(19) United States
(12) Patent Application Publication
(10) Pub. No.: US 2024/0409709 A1
(43) Pub. Date: Dec. 12, 2024

(54) METAL-OXIDE-COATED THERMOPLASTIC MICROPARTICLES HAVING BIODEGRADABILITY

(71) Applicant: Wacker Chemie AG, Munich (DE)

(72) Inventor: Sebastian Knör, Munich (DE)

(73) Assignee: Wacker Chemie AG, Munich (DE)

(21) Appl. No.: 18/700,803

(22) PCT Filed: Dec. 16, 2021
(86) PCT No.: PCT/EP2021/086197

§ 371 Date: Apr. 12, 2024

(51) Int. Cl. C08K 3/22; C08K 3/36

(52) U.S. Cl. CPC C08K 3/22; C08K 3/36; C08K 2003/2227; C08K 2003/2241; C08K 2201/006; C08K 2201/009

(57) ABSTRACT

Core-shell particles and processes for producing the same. Where the core-shell particles include a core (B) and a shell (D). The core (B) includes a thermoplastic polyester (C) with a melting range of lower than 160° C. and the shell (D) includes partially water-wettable particles (E) of metal oxide. Where the partially water-wettable particles (E) have a methanol value of less than 30 and the metal content of the core-shell particles (A) is at least 2.5% by weight.

The invention relates to core-shell particles formed from a core of thermoplastic polyester, the melting range of which is lower than 160° C., and a shell of partially water-wettable particles of metal oxide and to a process for producing core-shell particles.

Various spherical silica-coated silicon microparticles are known from the prior art that have a good skin feel in cosmetic uses, but are not biodegradable. The use of such particles is not sustainable and is prohibited or restricted in many uses by legal regulations.

Silicon-based core-shell particles, for example those described in WO2021/121562 and WA11955S WO2021/12156, have a partially hydrophobized surface and their amphiphilic character makes them readily dispersible in aqueous and organic media. In addition, such particles are virtually agglomeration-free and thus form a fine and free-flowing powder. However, a drawback of these particles is that they are not biodegradable.

Biodegradable polyester microparticles of the prior art, for example those described in EP3489281 and JP6543920 B2, are hydrophobic and difficult to disperse in aqueous products. Moreover, such uncoated particles have a high tendency to agglomerate and thus to adhere to one another.

The invention provides core-shell particles (A) formed from
a core (B) comprising a thermoplastic polyester (C), the melting range of which is lower than 160° C., and
a shell (D) comprising partially water-wettable particles (E) of metal oxide, the particles (E) having a methanol value of less than 30,
where the metal content of the core-shell particles (A) is at least 2.5% by weight.

Surprisingly, the core-shell particles (A) of the invention are easily biodegradable (“ready biodegradability”), which can be determined by the CO₂ evolution test (Sturm test) according to OECD 301 B. This is very surprising and not foreseeable, since it is known to those skilled in the art that the partially water-wettable particles (E) that form a permanently attached shell (D) around the core (B) of biodegradable thermoplastic polyester are themselves difficult to dissolve and not biodegradable. The core-shell particles (A) of the invention accordingly meet the demand of the cosmetics industry for environmentally friendly, biodegradable microparticles.

The permanently attached shell (D) of partially water-wettable particles (E) is a significant advantage over prior art thermoplastic polyester particles that are treated in the solid state with a finely-divided particles, for example with a silica as an antiblocking agent or as a flow improver. In such particles, the silica is not permanently attached to the surface.

The core-shell particles (A) of the invention are amphiphilic, that is to say they are both hydrophilic (i.e. water-loving) and lipophilic (i.e. fat-loving). This means that the core-shell particles (A) of the invention are readily dispersible both in polar solvents, for example water or alcohols, and in nonpolar solvents, for example aliphatic hydrocarbons, or polydimethylsiloxane oils, without the addition of further dispersing aids or additives such as organic emulsifiers or other surface-active substances. This is a significant advantage of the particles (A) compared to uncoated prior art particles that are very hydrophobic and not dispersible in polar solvents, for example water or alcohols, without the use of undesirable auxiliaries such as organic emulsifiers. In the core-shell particles (A) of the invention, the particle (E) is firmly attached to the surface, as a result of which the amphiphilic properties are maintained during dispersion in a solvent. This is a significant advantage over prior art thermoplastic polyester particles that after curing undergo aftertreatment with silica, since the silica is not permanently attached in these noninventive particles.

The core-shell particles (A) of the invention have a structured surface and thus have improved oil absorbency compared to conventional, non-coated thermoplastic polyester particles of the prior art, for example those described in U.S. Ser. No. 11/078,338 BB and JP6794499 B2.

The invention also relates to a process for producing core-shell particles (A) formed from
a core (B) comprising a thermoplastic polyester (C), the melting range of which is lower than 160° C., and
a shell (D) comprising partially water-wettable particles (E) of metal oxide, the particles (E) having a methanol value of less than 30,
where the metal content of the core-shell particles (A) is at least 2.5% by weight, in which,
in a first step, the thermoplastic polyester (C) is heated to above its melting range, and accordingly becomes free-flowing, and emulsified with the particles (E) in water,
forming a particle-stabilized oil-in-water emulsion (G) having a discontinuous phase comprising molten polyester (C) and a continuous water-containing phase,
and, in a second step, the emulsion (G) is cooled to below the melting range of the polyester (C), wherein the molten, particle-stabilized polyester droplets (C) solidify and the particles (E) become attached to the surface of the polyester particles (C), forming the core-shell particles (A).

The solidified thermoplastic melt (C) forms the core (B) of the core-shell particle (A) and the particulate emulsifier (E) forms its shell (D).

Any thermoplastic polyester (C) or blends of different thermoplastic polyesters (C) may in principle be used. The melting temperature is preferably in the range of 45 to 160° C., preferably in the range of 50 to 155° C., more preferably in the range of 85 to 150° C.

If the melting temperature is less than 45° C., the resulting particle (A) is no longer suitable for many uses, for example for products that are produced at elevated temperature, for example lipsticks, and this complicates storage, since the storage temperature must be monitored. If the melting temperature is greater than 160° C., then processing by the process of the invention is possible only with very high technical complexity and high costs. There is also a risk that the thermoplastic polyester (C) will become discolored or break down during processing at temperatures higher than 160° C.

Examples of suitable thermoplastic polyesters (C) include: polycaprolactone (PCL), poly(butylene succinate) (PBS), poly(butylene succinate adipate) (PBSA), poly(butylene adipate terephthalate) (PBAT), polyhydroxyalkanoate (PHA), polyhydroxybutyrate (PHB), polyhydroxyvalerate (PHV), poly(hydroxybutyrate hydroxyvalerate) copolymers (PHBV), or a blend thereof, preference being given to unblended polyesters.

Preference is given to polycaprolactone (PCL), poly(butylene succinate) (PBS), poly(butylene succinate adipate) (PBSA), poly(butylene adipate terephthalate) (PBAT) and poly(hydroxybutyrate-co-hydroxyvalerate) or a blend thereof, preference being given to unblended polyesters. Particular preference is given to poly(butylene succinate) (PBS), poly(butylene succinate adipate) (PBSA) and poly(butylene adipate terephthalate) (PBAT).

The term “biodegradable” used herein is to be understood as encompassing all polyesters that are degraded by the action of living organisms, light, air, water or a combination thereof. Biodegradation reactions are usually catalyzed by enzymes and generally take place in the presence of moisture. The hydrophilic/hydrophobic nature of the polymers has a major influence on their biodegradability, polar polymers normally being more readily biodegradable. Other important polymer properties that affect biodegradability are crystallinity, chain flexibility, and chain length.

Preferably, the thermoplastic polyester C is particularly easily biodegradable (“ready biodegradability”), which can be determined by the CO₂ evolution test (Sturm test) according to OECD 301 B. The method is based on the production of CO₂. At the end of what is termed the 10-day test window and after 28 days of testing, a biodegradability is determined. If the product has achieved the required level of degradation of at least 60% both at the end of the 10-day window and after 28 days of incubation, it is described as being readily biodegradable.

The core-shell particles (A) of the invention achieve a biodegradability according to OECD 301 B of at least 60%, preferably of at least 65%, more preferably of at least 70%.

The processability of the thermoplastic polyesters (C) can be improved by adding suitable additives, for example plasticizers, flow improvers or lubricants. Methods for this are known to those skilled in the art.

Further prior art additives that improve the properties of the thermoplastic can be added to the thermoplastic polyester (C). Examples include light stabilizers, antioxidants, fillers, dyes and pigments, plasticizers, and antistats. Other additives can improve processability. Examples include lubricants, heat stabilizers, and blowing agents.

Preferably, no further auxiliaries or additives are added.

Commercial thermoplastic polyesters often have a very high melt viscosity of greater than 500 000 mPa·s. Such polymer melts can be processed by the process of the invention, but their processing and emulsification involves relatively high technical complexity and generally affords only relatively large and/or irregularly shaped particles. Such products find use for example in cleansing creams, washing gels or exfoliating scrubs.

Preferred small-sized and essentially spherical microparticles are produced from thermoplastic polyester (C), the melt viscosity of which at the temperature during emulsification is less than 500 000 mPa·s, preferably less than 250 000 mPa·s, more preferably less than 150 000 mPa·s, in particular less than 100 000 mPa·s.

In the process of the invention, the partially water-wettable particle (E) acts as a particulate emulsifier and stabilizes the oil-in-water emulsion of the thermoplastic melt. Such emulsions are known as Pickering emulsions.

The particle (E) is a metal oxide having a covalent bonding component in the metal-oxygen bond, for example solid oxides of the main group and transition group elements, such as one of main group 3, such as boron oxide, aluminum oxide, gallium oxide or indium oxide, or one of main group 4, such as silicon dioxide, germanium dioxide, tin oxide or dioxide, or lead oxide or dioxide, or an oxide of the transition group elements, such as titanium dioxide, zirconium dioxide, hafnium dioxide, cerium oxide or iron oxide.

At room temperature and the pressure of the ambient atmosphere, i.e. 1013 hPa, the particle (E) is present as a solid particle.

Preferably, the particle (E) is a metal oxide having a covalent bonding component in the metal-oxygen bond, for example solid oxides of the main group and transition group elements, such as one of main group 3, such as boron oxide, aluminum oxide, gallium oxide or indium oxide, or one of main group 4, such as silicon dioxide, germanium dioxide, tin oxide or dioxide, or lead oxide or dioxide, or an oxide of the transition group elements, such as titanium dioxide, zirconium dioxide, hafnium dioxide, cerium oxide or iron oxide.

Preferably, the particles (E) are aluminum (III), titanium (IV) or silicon (IV) oxides, such as wet-chemically produced, for example precipitated, silicas or silica gels, or aluminum oxides, titanium dioxide or silicon dioxides produced in processes at elevated temperature, for example pyrogenic aluminum oxides, titanium dioxides or silicas, fumed silica being particularly preferred.

At pH 7.33, an electrolyte background of 0.11 mol, and a temperature of 37° C., the particle (E) preferably has a solubility in water of less than 0.1 g/l, more preferably of less than 0.05 g/l, at the pressure of the ambient atmosphere, i.e. 1013 hPa.

Preferably, the particle (E) has a molar mass of greater than 10 000 g/mol, more preferably a molar mass of from 50 000 to 50 000 000 g/mol, in particular from 100 000 to 10 000 000 g/mol, in each case measured preferably by static light scattering.

Preferably, the particle (E) has a BET specific surface area of 30 to 500 m²/g, more preferably 100 to 300 m²/g. The BET surface area is measured according to known methods, preferably according to German industry standards DIN 66131 and DIN 66132.

Preferably, the particle (E) has a Mohs hardness of greater than 1, more preferably of greater than 4.

The particle (E) is in particular characterized in that it is surface-treated with a suitable hydrophobizing agent and is as a result hydrophobic. The hydrophobization must be carried out such that the particle (E) is still partially water-wettable. In accordance with the invention, this means that the methanol value of the particle (E) is less than 30, preferably less than 25, more preferably less than 20.

As a result of surface treatment, preferred particles (E) have a carbon content of at least 0.2% to max. 1.5% by weight, preferably between 0.4% and 1.4% by weight, more preferably between 0.6% to 1.3% by weight. The hydrophobic groups are for example Si-bonded methyl or vinyl groups. Methods for the hydrophobization of silicas are known to those skilled in the art.

Very particular preference is given to partially water-wettable silicas as described in EP 1433749 A1 and DE 10349082 A1.

Particular preferred particles (E) are silanized fumed silicas having a methanol value of less than 30.

In this case, the average particle size of the particle (E) or particle aggregates, if present, is preferably smaller than the median diameter ×50 of the droplets without the fine particles.

The average particle size of the particle (E) is preferably smaller than 1000 nm, more preferably between 10 nm and 800 nm, particularly preferably between 50 nm and 500 nm, and most preferably between 75 nm and 300 nm, in each case measured as the average hydrodynamic equivalent diameter by photon correlation spectroscopy at 173° (backscattering) with a Nanosizer ZS from Malvern.

To determine the methanol value, defined mixtures of water with methanol are prepared and then the surface tensions of these mixtures determined using known methods. In a separate experiment, these water-methanol mixtures are overlayered with defined amounts of particles and shaken under defined conditions (for example, gentle manual shaking or shaking with a tumble mixer for approx. 1 minute). The water-alcohol mixture in which the particles do not yet sink and the water-alcohol mixture with a higher alcohol content in which the particles just sink is determined. The surface tension of the latter alcohol-water mixture gives the critical surface energy γcrit as a measure of the surface energy γ of the particles. The methanol content in water gives the methanol value.

The core-shell particles (A) of the invention preferably have a size ×50 of from 1 to 100 μm, preferably from 2 to 50 μm, more preferably from in particular 2 to 20 μm, in particular from 3 to 10 μm.

The core-shell particles (A) of the invention are preferably essentially spherical. Preferably, the sphericity SPHT3 is at least 0.80, preferably at least 0.82, in particular at least 0.85, which can be determined according to ISO 9276-6 using a Camsizer X2 from Retsch Technology.

The particles (A) of the invention have a core-shell structure, wherein the thermoplastic polyester (C) forms the core and the particulate emulsifier (E) forms the shell.

The core of the core-shell particles (A) of the invention is essentially filled and free of pores. They differ in this regard from porous particles, which are described for example in JP6543920 B2. Particles produced according to EP3489281A1 have also been found to have a porous structure. A drawback of porous particles of this kind is their high tendency to float when incorporated into liquid products, as a result of trapped air bubbles.

The particles (A) are in particular characterized in that the employed particles (E) are essentially attached to the surface of the polymer particles (A), thereby forming a shell (D) around the core (B) of thermoplastic polyester (C). The distribution of the employed particles (E) can be obtained from TEM images of thin sections of embedded particles of the invention. The average diameter of the shell (D) of particles (E) is preferably greater than 10 nm, more preferably greater than 20 nm, particularly preferably greater than 30 nm.

The core-shell particles (A) of the invention are characterized in that the shell (D) is permanently attached. “Permanently attached” in this context means that the average diameter of the shell (D), even after washing the particles with water three times, is preferably greater than 10 nm, more preferably greater than 20 nm, particularly preferably greater than 30 nm.

Preferred core-shell particles (A) have a shell (B) of partially water-wettable silica, wherein the silicon content is at least 1% by weight, preferably at least 2% by weight, more preferably at least 3% by weight, particularly preferably at least 4% by weight, in each case based on the core-shell particles (A).

The linseed oil absorption of the core-shell particles (A) of the invention is preferably in the range of 150 ml to 300 ml per 100 g of particles (A), more preferably in the range of 160 ml to 250 ml per 100 g of particles (A), particularly preferably in the range of 200 ml to 250 ml per 100 g of particles (A), measured according to the method described in EP3489281 A1.

The linseed oil absorption of the particles (A) is measured using a method modified from the measurement method in JIS K 5101-13-2-2004, in which purified linseed oil is used instead of boiled linseed oil and the end point is the point at which the paste of particles (A) mixed and kneaded with purified linseed oil starts flowing when the measurement plate is in an upright position. The detailed measurement of the linseed oil absorption is as follows.

### (A) Instrument and Tools

Measurement plate: a smooth glass plate larger than 300×400×5 mm
Palette knife (spatula): made of steel or stainless steel, having a blade and a handle
Chemicals balance: allows measurements up to 10 mg
Buret: according to JIS R 3505:1994 with a capacity of 10 ml

### (B) Reagent

Purified linseed oil: according to ISO 150:1980 (in the present examples, linseed oil of the first grade (produced by Wako Pure Chemical Industries Ltd.) is used).

### (C) Measurement Method

(1) Particles (A) (1 g) are placed in the center of the measurement plate, purified linseed oil is gradually added to the center of the particles (A) from the buret 4 to 5 drops at a time, and the particles (A) and purified linseed oil are thoroughly kneaded with the palette knife after each dropwise addition.
(2) After repeated dropwise addition and kneading and when the particles (A) and the purified linseed oil form a putty-like solid mass, purified linseed oil is added dropwise and the point at which the paste (particles (A) mixed and kneaded with purified linseed oil) suddenly becomes soft and starts flowing after addition of a drop of purified linseed oil is considered the end point.
(3) Judgement of flowing

When the paste suddenly becomes soft and moves with the measurement plate in the upright position after addition of a drop of purified linseed oil, the paste is considered to be flowing. If the paste does not move when the measurement plate is in the upright position, another drop of purified linseed oil is added.
(4) The amount of purified linseed oil consumed at the end point is read, this being the amount by which the liquid has fallen in the buret.
(5) A measurement is performed such that the measurement is completed within 7 to 15 minutes. If the measurement takes longer than 15 minutes, another measurement is performed and the result is taken as the value obtained from the measurement completed within the specified time.
(D) Calculation of linseed oil absorption

The linseed oil absorption per 100 g of sample is calculated according to the following equation:

$$O = ( V / m ) \times 100$$

where O: linseed oil absorption (ml/100 g), m: weight (g) of particles (A), V: volume (ml) of purified linseed oil consumed.

The process for producing the core-shell particles (A) does not involve the use of organic auxiliaries, emulsifiers or solvents.

Preferably, a three-phase mixture is formed in which an emulsion (G) of sparingly water-soluble and water-immiscible molten and accordingly free-flowing thermoplastic polyester (C) is produced, which are stabilized in the water phase by partially water-wettable particles (E) (Pickering emulsions).

It is surprisingly possible by the process of the invention to produce Pickering emulsions (G) of molten thermoplastic polyester at high temperatures, thereby avoiding the disadvantageous use of organic solvents.

Therefore, in a preferred embodiment, the polyester (C) heated to above the melting range is emulsified with exclusion of an organic solvent.

The particle-stabilized oil-in-water emulsion (G) has a continuous water phase, which in the second step the continuous water phase is unchanged.

Preferably, the continuous phase contains at least 80% by weight, in particular at least 90% by weight, of water.

The size of the particles (A) can be determined for example by the emulsifying technique, thus for example by variables such as the input shear energy, the volume fraction of the thermoplastic polyester (C), the amount of partially water-wettable particles (E), the pH of the continuous water phase and ionic strength thereof, the viscosity, the dosing sequence, the dosing rate, or by the process regime, i.e. for example by the temperature, the mixing time, and the concentrations of the employed raw materials.

When using an emulsifying technique that allows the production of relatively small droplets, this process affords small surface-structured particles (A). To this end, it is for example possible for different shear energies or a selection of different partially water-wettable particles (E) to be used to stabilize the molten and accordingly free-flowing thermoplastic polyester (C) in water.

The emulsions (G) may optionally comprise an organic emulsifier.

What is meant here by organic emulsifiers is not particles and colloids, but rather molecules and polymers according to the definition of molecules, polymers, colloids, and particles given in Dispersionen and Emulsionen [Dispersions and emulsions], G. Lagaly, O. Schulz, R. Zindel, Steinkopff, Darmstadt 1997, ISBN 3-7985-1087-3, pp. 1-4.

In general, these organic emulsifiers have a size of less than 1 nm, a molar mass of <10 000 g/mol, a carbon content of >50% by weight, determinable by elemental analysis, and a Mohs hardness of less than 1.

At the same time, the organic emulsifiers, which are essentially absent in the emulsions of the invention, generally have a solubility in water in homogeneous or micelle form of greater than 1% by weight at 20° C. and the pressure of the ambient atmosphere, i.e. 1013 hPa.

The emulsions (G) may contain such organic emulsifiers up to a maximum concentration of less than 0.1 times, preferably less than 0.01 times, more preferably less than 0.001 times, in particular less than 0.0001 times, the critical micelle concentration of these organic emulsifiers in the water phase; this corresponds to a concentration of these organic emulsifiers, based on the total weight of the dispersion of the invention, of less than 10% by weight, preferably less than 2% by weight, more preferably less than 1% by weight, in particular 0% by weight.

Preferably, the particle-stabilized Pickering emulsion (G) are essentially free of conventional organic surface-active substances that are non-particulate liquids and solids at room temperature and the pressure of the ambient atmosphere, such as nonionic, cationic, and anionic emulsifiers (“organic emulsifiers”).

### First Process Step

The thermoplastic polyester (C) is heated to above the melting range, becoming molten and free-flowing, and is emulsified with partially water-wettable particles (E) in water, forming a particle-stabilized oil-in-water emulsion (Pickering emulsion).

Preferably, a dispersion (H) of the partially water-wettable particles (E) in water is produced before mixing with molten and accordingly free-flowing thermoplastic polyester (C).

The dispersion (H) can in principle be produced according to the known processes for producing particle dispersions, such as incorporation using agitators with a high shear effect such as high-speed stirrers, high-speed dissolvers, rotor-stator systems, ultrasonic dispersers or ball/bead mills.

The concentration of the partially water-wettable particle (E) in the dispersion (H) here is between 1% and 80% by weight, preferably between 10% and 60% by weight, more preferably between 10% and 40% by weight, and most preferably between 12% and 30% by weight.

For the production of the particle-stabilized Pickering emulsion (G) in the first step, it is possible to use any method for producing emulsions known to those skilled in the art. However, it was found that emulsions particularly suitable for producing the particles (A) can be obtained according to the following processes:

### Process 1:

A highly concentrated dispersion (H) is initially charged, the volume initially charged being such that it contains the total amount of particles (E) needed and only part of the volume of water.
The total volume of polyester (C) is metered in slowly under constant homogenization, for example by means of a high-speed stirrer, high-speed dissolver or a rotor-stator system.
The rest of the desired volume of water in then metered in slowly, optionally under constant homogenization, for example by means of a high-speed stirrer, high-speed dissolver or a rotor-stator system.

### Process 2:

A dispersion (H) of particles (E) is initially charged, the volume initially charged being such that it contains the total amount of particles (E) needed and water.
The total volume of polyester (C) is metered in slowly under constant homogenization, for example by means of a high-speed stirrer, high-speed dissolver, rotor-stator system or capillary emulsifier.

### Process 3:

The total volume of polyester (C) is initially charged.
A highly concentrated dispersion (H) of particles (E) in water is metered in slowly under constant homogenization, for example by means of a high-speed stirrer, high-speed dissolver or a rotor-stator system, the volume initially charged being such that it contains the total amount of particles (E) needed and only part of the volume of water.
The rest of the desired volume of water in then metered in slowly, optionally under constant homogenization, for example by means of a high-speed stirrer, high-speed dissolver or a rotor-stator system.

### Process 4:

The total volume of polyester (C) is initially charged.
The dispersion (H) of particles (E) in water is metered in slowly under constant homogenization, for example by means of a high-speed stirrer, high-speed dissolver or a rotor-stator system, the volume initially charged being such that it contains the total amount of particles (E) needed and water.

### Process 5:

The total volume of polyester (C) and the dispersion (H) of particles (E) in water are initially charged, the volume initially charged being such that it contains the total amount of particles (E) needed and water.
Homogenization of both together, for example by means of a high-speed stirrer, high-speed dissolver or a rotor-stator system.

### Process 6:

The total volume of polyester (C) and a highly concentrated dispersion (H) of particles (E) in water are initially charged, the volume initially charged being such that it contains the total amount of particles (E) needed and part of the volume of water.
Homogenization of both together, for example by means of a high-speed stirrer, high-speed dissolver or a rotor-stator system.
The rest of the desired volume of water is then metered in slowly, optionally under constant homogenization, for example by means of a high-speed stirrer, high-speed dissolver or a rotor-stator system.

Preference is given to processes 1, 2, 5, and 6, processes 2 and 5 being more preferred and process 5 particularly preferred.

The homogenization is carried out preferably in at least one process step for at least 30 seconds, preferably at least 1 minute.

The dispersion (H) of the particles (E) in water, which forms the homogeneous phase in the emulsion (G), can in principle be produced according to the known processes for producing particle dispersions, such as incorporation using agitators with a high shear effect such as high-speed stirrers, high-speed dissolvers, rotor-stator systems, ultrasonic dispersers or ball/bead mills.

The described processes can be carried out either continuously or discontinuously. Continuous performance is preferred.

The temperature in the first step is above the melting temperature of the thermoplastic polyester (C), above which the the thermoplastic polyester (C) goes into a free-flowing state, preferably within a temperature range of between 45 to 180° C., preferably 50° C. to 170° C., more preferably 85° C. to 165° C. Preferably, the temperature in the first step is at least 5° C., preferably at least 10° C., above the melting temperature of the thermoplastic polyester (C). A higher processing temperature can lead to discoloration and decomposition of the thermoplastic polyester and significantly increases the technical complexity of processing.

The emulsification process in the first step can be carried out at standard pressure, i.e. at 900 to 1100 hPa, at elevated pressure, or under reduced pressure. If the process temperature is below 100° C., then the process at standard pressure is preferred. If the process temperature is above 100° C., then the process at elevated pressure is preferred, the selected pressure preferably being sufficiently high that the boiling temperature is above the process temperature. The dependence of the physical state of water on pressure and temperature is known to those skilled in the art. For example, water is in a liquid state at a temperature of 160° C. and pressure of 10 bar. Preferably, the pressure in the emulsification process is less than 50 bar, more preferably less than 20 bar, particularly preferably less than 10 bar.

The concentration of the partially water-wettable particles (E) in the three-phase mixture (G) of dispersion (H) and thermoplastic polyester (C) from the first step is between 1% and 20% by weight, preferably between 2% and 15% by weight, more preferably between 3% and 12% by weight.

The concentration of the molten and accordingly free-flowing thermoplastic polyester (C) in the three-phase mixture (G) of dispersion (H) and thermoplastic polyester (C) from the first step here is between 50% and 80% by weight, preferably between 53% and 70% by weight, more preferably between 55% and 68% by weight.

The concentration of water in the three-phase mixture (G) of dispersion (H) and thermoplastic polyester (C) from the first step here is between 10% and 48% by weight, preferably between 15% and 45% by weight, more preferably between 23% and 40% by weight, and most preferably between 25% and 36% by weight.

In an optional process step, the Pickering emulsion (G) is diluted with water, optionally under constant homogenization, for example by means of a high-speed stirrer, high-speed dissolver or a rotor-stator system.

### Optional Upstream Process Step (Lowering of Melt Viscosity):

The melt viscosity of the thermoplastic polyester (C) can be reduced in an optional process step prior to production of the three-phase mixture (G), thereby improving emulsifiability. Suitable processes are known to those skilled in the art.

Preferably, the melt viscosity is reduced by a transesterification reaction, for example by reacting a thermoplastic polyester having a relatively high melt viscosity with a thermoplastic polyester having a relatively low melt viscosity, thereby reducing the melt viscosity, it being possible for said polyesters to be chemically identical or chemically different.

Likewise, a thermoplastic polyester having a high melt viscosity can be reacted with a suitable end stopper (1), preferably a monofunctional alcohol or a monofunctional carboxylic acid, in a transesterification reaction, thereby reducing the melt viscosity. The monofunctional alcohol or monofunctional carboxylic acid acts here as an end group. It is also possible to use any desired combination of thermoplastic polyester (C) having a relatively low melt viscosity and monofunctional alcohols and monofunctional carboxylic acid. Preference is given to monofunctional alcohols.

The melt viscosity of the thermoplastic polyester (C) can be regulated by the type and amount of thermoplastic polyester having a relatively low melt viscosity or alcohol or carboxylic acid, wherein the larger the used, the lower the resulting melt viscosity. This is known to those skilled in the art. Those skilled in the art also know that the type and amount of thermoplastic polyester with relatively low melt viscosity or alcohol or carboxylic acid selected for the reaction also influence the chemical, physical, and mechanical properties of the resulting thermoplastic polyester. For example, the hardness, toughness, elasticity or polarity may be increased or decreased.

Preferably, the boiling point of the monofunctional alcohol or monofunctional carboxylic acid is above the melting temperature of the thermoplastic polyester (C).

Any monofunctional alcohol is suitable in principle. For example, these may be primary, secondary, or tertiary alcohols having aliphatic or aromatic groups, preferably primary or secondary alcohols, more preferably primary alcohols. The alcohol may be branched or linear, bear aromatic or functional groups, and be saturated or unsaturated. It may also be a polyether that is hydroxy-functional at one end. Mixtures of monofunctional alcohols may also be used.

Preferred alcohols are monofunctional saturated or unsaturated alcohols having aliphatic or aromatic groups, preferably C4-C30, preferably C6-C26. Particular preference is given to primary aliphatic C6-C12 alcohols and mixtures thereof, and also primary aliphatic C16-C24 alcohols and mixtures thereof.

Any monofunctional carboxylic acid is suitable in principle. For example, they may be carboxylic acids having aliphatic or aromatic groups. The carboxylic acid may be branched or linear, bear aromatic or functional groups, and be saturated or unsaturated. It may also be a polyester that is carboxy-functional at one end. Mixtures of monofunctional carboxylic acids may also be used.

Preferred carboxylic acids are monofunctional saturated or unsaturated carboxylic acids having aliphatic or aromatic groups, preferably C4-C30, preferably C6-C26. Particular preference is given to monofunctional aliphatic C6-C12 carboxylic acids and mixtures thereof, and also monofunctional aliphatic C16-C24 carboxylic acids and mixtures thereof.

The transesterification reaction is preferably accelerated with a suitable catalyst. These are known to those skilled in the art. Suitable catalysts are for example inorganic or organic acids or bases, metal salts and metal complexes of for example lithium, aluminum, titanium, zirconium, tin or lead.

Examples of such catalysts are in particular carboxylic acid salts of tin or zinc, wherein hydrocarbon radicals may be directly attached to tin, such as di-n-butyltin dilaurate, tin octoate, di-2-ethyltin dilaurate, di-n-butyltin di-2-ethylhexoate, or di-2-ethylhexyltin di-2-ethylhexoate, dibutyl- or dioctyltin diacylates where the acylate groups are in each case derived from alkanoic acids having 3 to 16 carbon atoms per acid in which at least two of the valences of the carbon atom attached to the carboxyl group are occupied by at least two carbon atoms other than that of the carboxyl group, and zinc octoates. Other examples of catalysts (3) are alkoxytitanates, such as butoxytitanates and triethanolamine titanate, and also zirconium and aluminum compounds, in particular the carboxylic acid salts and alkoxides thereof.

Preferably, the condensation catalyst is used in amounts of from 0.1% to 10% by weight based on the sum total of polyester (C) and alcohol or carboxylic acid.

The transesterification reaction is preferably carried out within a temperature range of between 40 to 200° C. for a period of between 30 minutes to 48 h, preferably within a temperature range of between 60 to 180° C. for a period of between 60 minutes to 24 h. A longer reaction time reduces polydispersity and improves quality.

For the transesterification reaction, the thermoplastic polyester (C) can be dissolved in a suitable solvent. Preferably, the transesterification reaction is carried out without addition of a solvent.

In a preferred embodiment, the transesterification reaction is carried out without addition of a solvent at a temperature above the melting range of the thermoplastic polyester (C).

Examples of suitable mixers are laboratory stirrers, kneaders, planetary mixers or dissolvers, rotor-stator systems, or else extruders, etc.

In a preferred embodiment, the optional upstream process step (lowering of melt viscosity) is carried out.

Starting from the three-phase mixture (G) described above, the particles (A) are obtained in a second process step by cooling the Pickering emulsion (G) to below the melting temperature of the thermoplastic polyester (C).

Preferably, the three-phase mixture (G) is cooled in the second process step to a temperature 10° C. below the melting temperature of the thermoplastic polyester (C), preferably 20° C. below the melting temperature, more preferably 30° C. below the melting temperature. In a particularly preferred embodiment, the temperature of the three-phase mixture (G) is cooled to less than 40° C., preferably less than 30° C., before the particles (A) are isolated or processed further.

In the second step, the process must be carried out such that, during cooling, the partially water-wettable particles (E) stabilizing the discontinuous phase enter into a stable interaction with the surface of the thermoplastic polyesters (C) forming the cores, for example hydrogen bonds, van der Waals interactions, or any other directional interaction, or a combination of such directional interactions, with the result that the partially water-wettable particles (E) are permanently anchored to the cores formed from thermoplastic polyester (C).

The duration of the second process step is preferably shorter than 24 h, preferably between 0 h to 18 h, more preferably 0.1 h to 6 h, and in a specific execution 0.15 h to 2 h.

Optionally, water can be added to the three-phase mixture (G), thereby cooling the mixture.

Optionally, dispersing aids, protective colloids and/or surfactants may be added to the three-phase mixture (G). These may be added in the first step or before or during the second step.

Preferably, the three-phase mixture (G) contains less than 5% by weight, more preferably less than 1% by weight, in particular less than 0.1% by weight, of dispersants, protective colloids, and surfactants. In a specific execution, the three-phase mixture is free of dispersing aids, protective colloids, and surfactants.

Optionally, the three-phase mixture (G) comprises inorganic or organic electrolytes. These may be added either after the first step, during the second step, or after completion of the second step.

The ionic strength of the three-phase mixture is in this case between 0.01 mmol/1 and 1 mol/1, preferably between 0.1 mmol/1 and 500 mmol/1, and more preferably between 0.5 mmol/1 and 100 mmol/1.

Optionally, the surface of the particles (A) may be modified by treatment with reactive silanes or siloxanes. These may be added either immediately after completing the production of the Pickering emulsion (G) in the first step, during the reaction phase or after completing the reaction phase in the second step, before the isolation of the particles (A) or after the isolation of the particles in the liquid or solid phase. The treatment must be carried out such that covalent chemical binding of the silane or siloxane to the particles (A) occurs. Suitable methods and processes are known to those skilled in the art.

The solids content of the particles (A) in the three-phase mixture (G) consists of the sum total of thermoplastic polyester (C) and partially water-wettable particles (E). Preferably, the solids contents of the three-phase mixture during the second process step is in the range between 5% by weight and 70% by weight, preferably between 20% by weight and 60% by weight, more preferably between 35% by weight and 50% by weight.

If the solids content is higher, there is a risk that the particles (A) will stick together.

Optionally, the three-phase mixture (G) after the second step may be stored for a continued period with stirring. This may be done for example by means of a paddle stirrer or anchor stirrer.

In a preferred embodiment, the particles (A) are isolated, preferably by sedimentation, filtration or centrifugation, more preferably by filtration or centrifugation, particularly preferably by centrifugation.

After isolation, the particles (A) are preferably washed with a washing liquid preferably selected from demineralized water, methanol, ethanol, and mixtures thereof.

In a preferred embodiment, the particles (A) are isolated from the aqueous phase in powder form. This may be done for example by filtration, sedimentation, centrifugation or by removing volatiles by drying in ovens or dryers or by spray drying or by applying an appropriate reduced pressure.

If the particles (A) undergo mixing during drying, as is the case for example during spray drying, cone drying, paddle drying or fluidized-bed drying, a very high particle fineness (A) can be achieved without further processing. Statically dried particles (A) tend to form loose agglomerates that can be deagglomerated by gentle processes such as sieving or mixing. Optionally, the particles (A) can also be deagglomerated by suitable milling processes, such as a ball mill or air-jet mill.

The particles (A) can be used as constituents for, inter alia, cosmetics, such as foundations, antiperspirants, and exfoliating scrubs; auxiliaries for paints, flatting agents or rheology-altering agents for paints, rheology modifiers, antiblocking agents, lubricants, light-scattering agents, auxiliaries for fine ceramics, such as sinter molding or a constituent of fine ceramics, fillers for adhesives, agents for medical diagnostics and the like; additives for molded articles such as automotive materials, building materials, and the like.

### Measurement Methods

### Median Particle Diameter (×50 Value):

The particle size (median diameter ×50) and sphericity SPHT analyses were carried out using a Camsizer X2 from Retsch Technology (measurement principle: dynamic image analysis) according to ISO 13322-2 and ISO 9276-6 (analysis type: dry measurement of powders and granulates; measurement range: 0.8 μm to 30 mm; compressed air dispersion with “X-Jet”; dispersion pressure=0.3 bar). Evaluations were performed on a volume basis according to the x_{c min} model.

### Melting Point

Determination by differential scanning calorimetry (DSC) according to DIN EN ISO 11357-3 using a Netzsch DSC 214 Polyma analyzer: sample weight: 8.5 mg, temperature range −70 to 150° C., heating/cooling rate 10 K/min; the measurement comprised two runs (each run consists of the following heating and cooling cycle: from −70° C. (10 K/min) to 150° C. and from 150° C. (10 K/min) to −70° C.); the second run was used for the evaluation.

### Molecular Weight Determination

The weight-average molecular weight Mw and number-average molecular weight Mn were determined by size-exclusion chromatography (SEC) against a polystyrene standard in THE on a Styragel HR1-HR3-HR4-HR5 column set from Waters Corp. USA, with an injected volume of 10 μl and a sample concentration of 10 mg/ml, at 60° C., a flow rate of 0.4 ml/min, and with detection by RI (refractive index detector).

### Melt Viscosity

The melt viscosity was determined on an Anton Paar MCR 302 rheometer in accordance with DIN EN ISO 3219-1/2 and DIN 53019 using a temperature ramp with decreasing deformation and constant frequency with parallel plate/plate.

The measurement parameters were chosen as follows:
Measurement system PP25 (calculation mode: conversion constant at maximum radius)
Measurement point recorded every 30 seconds

### First Section

Temperature ramp: from 180° C. to −50° C. (2 K/min)
Deformation ramp: logarithmic from 0.2% to 0.1%
Frequency: 1 Hz
Normal force detection->if exceeding 10 N as a result of sample shrinkage, there was a jump to a further section with modified parameters (see second section)

### Second Section:

Temperature ramp: further cooling at 2 K/min to −50° C.
Deformation: constant 0.01%
Frequency: 1 Hz
Normal force regulation −1 N (this allows the gap to be adjusted and thermal shrinkage of the material compensated)

The reported melt viscosity in mPa·s is the interpolated value for the complex viscosity at a temperature of 80° C. or 120° C.

### Silicon Content (% Si by Weight)

The silicon content was determined by ICP (inductively coupled plasma) emission spectrometry. The samples were digested by a closed melt digestion with sodium peroxide (Wurzschmitt digestion). The ICP-OES determination is based on ISO 11885 “Water quality—Determination of selected elements by inductively coupled plasma optical emission spectrometry (ICP-OES) (ISO 11885:2007); German version EN ISO 11885:2009”, which is used for analysis of acidic aqueous solutions (for example acidified drinking water, wastewater, and other water samples and aqua regia extracts of soils and sediments).
Methanol value: For the determination of the methanol value, defined mixtures of water and methanol are prepared. In a separate experiment, these water-methanol mixtures are overlayered with the same volume of dried particles and shaken under defined conditions (for example, gentle shaking by hand or with a tumble mixer for approx. 1 minute). The water-alcohol mixture in which the particles do not yet sink and the water-alcohol mixture with a higher alcohol content in which the particles just sink are determined. The latter methanol content in water gives the methanol value.
The kinematic viscosity is measured according to DIN 53019 at 25° C.

In the examples that follow, unless stated otherwise in each case, all amounts and percentages are based on weight, all pressures are 0.10 MPa (abs.), and all temperatures are 20° C.

### EXAMPLES

TABLE 1
Analytical data of the silica particles used in the examples
and silica particles from the prior art

| | Carbon | Methanol | |
|---|---|---|---|
| | content | value | |
| | (% by | (% by | |
| | weight) | weight) | |
| Silica 1 | 0.9 | 5 | inventive |
| Silica 2 | 1.4 | 45 | noninventive |
| Aerosil R 972 | 1.0 | 45 | noninventive, |
| | | | used in US11078338 BB |
| | | | comparative examples 2, 3, 4, 5, |
| | | | 6, 7, 10 |
| Aerosil R 974 | 1.0 | 40 | noninventive, |
| | | | used in US11078338 BB |
| | | | comparative example 11 |
| Aerosil R 976 | 2.2 | 48 | noninventive, |
| S. | | | used in US11078338 BB |
| | | | comparative example 8 |

Silica 1 is a partially hydrophobized and partially water-wettable fumed silica (E) according to EP 1433749 A1 that is employed according to the invention.

Silica 2 is a noninventive hydrophobic fumed silica in accordance with U.S. Ser. No. 11/078,338 BB.

TABLE 2
Overview of the polyesters used in the examples

| | | | | | | Melt | Melt |
|---|---|---|---|---|---|---|---|
| | | | | | Melting | viscosity | viscosity |
| Thermoplastic | | Mw | Mn | Polydispersity | point | (mPa · s | (mPa · s at |
| polymer | Description | (g/mol) | (g/mol) | D | (° C.) | at 80° C.) | 120° C.) |
| Poly-ε- | Placcel | 25137 | 7646 | 3.3 | 60 | 11703 | n.d. |
| caprolactone | H1P | | | | | | |
| (PCL) | (Daicel | | | | | | |
| | Chemical | | | | | | |
| | Industries | | | | | | |
| | Ltd.) | | | | | | |
| Poly(butylene | BioPBS ™ | 132300 | 27900 | 4.7 | 87 | n.d. | 4090545 |
| succinate-co- | FD92 | | | | | | |
| adipate) | (Mitsubishi | | | | | | |
| (PBSA) | Chemical | | | | | | |
| | Performance | | | | | | |
| | Polymers) | | | | | | |
| Poly(butylene | BioPBS ™ | 119600 | 27600 | 4.3 | 116 | n.d. | 1694684 |
| succinate) | FZ71 | | | | | | |
| (PBS) | (Mitsubishi | | | | | | |
| | Chemical | | | | | | |
| | Performance | | | | | | |
| | Polymers) | | | | | | |
| Poly(butylene | TH801T | 101300 | 24700 | 4.1 | 120 | n.d. | 8741921 |
| adipate-co- | (Xinjiang | | | | | | |
| terephthalate) | Blue Ridge | | | | | | |
| (PBAT) | Tunhe | | | | | | |
| | Polyester | | | | | | |
| | Co., Ltd.) | | | | | | |

n.d. = not determined

### Example 1: Preparation of an Aqueous Silica Dispersion (H) Containing 20% by Weight of Silica 1 (Inventive)

1300 g of partially water-wettable silica 1 having a carbon content of 0.9% and a methanol value of 5% by weight, obtained by reacting a hydrophilic starting silica having a BET specific surface area of 200 m2/g (available under the HDK® N20 name from Wacker-Chemie GmbH, Munich) with dimethyldichlorosilane according to EP 1433749 A1 is stirred a little at a time into 5200 g of demineralized water in a dissolver at 650 rpm. At the end of the addition of the silica, the mixture is further dispersed at 650 rpm for a further 60 min. A highly viscous dispersion having a solids content of 20% and a pH of 4.2 is obtained.

### General Work Instruction AA1 for the Transesterification of Polyesters (Inventive)

The thermoplastic polyester (C) and end stopper (I) are melted in a commercially available vertical kneader (Grieser Maschinenbau—und Service GmbH, Chemiestrasse 19-21, 68623 Lampertheim, Germany) at an internal temperature of 150° C. The condensation catalyst is then added and the mixture is kneaded at 150° C. for 16 h. During the reaction, the melt viscosity of the mixture decreases, with a consequent decrease in the power consumption of the kneader. The power consumption is stable after approx. 2 h. At the end of the mixing time, the hot melt is poured onto Teflon® film, cooled to room temperature, and then crushed.

TABLE 3

| Example | | 2 | 3 | 4 | 5 | 6 |
|---|---|---|---|---|---|---|
| Thermoplastic | BioPBS ™ | 800 | — | — | — | — |
| polyester (C) | FD92 (g) | | | | | |
| | BioPBS ™ | — | 742 | — | — | — |
| | FZ71 (g) | | | | | |
| | TH801T (g) | — | — | 746 | 742 | 742 |
| End stopper (I) | 1-Octanol (g) | — | — | 4 | — | — |
| | 1-Decanol (g) | | | | | |
| | 1-Octadecanol | 25 | 8 | — | 8 | — |
| | (g) | | | | | |
| | Stearic acid | — | — | — | — | 8 |
| Catalyst | Tetra-n-butyl | 4 | 4 | 4 | 4 | 4 |
| | titanate (g) | | | | | |
| Mw (g/mol) | | 31200 | 33300 | 24800 | 28600 | 35200 |
| Mn (g/mol) | | 10300 | 12200 | 9000 | 14200 | 10100 |
| D | | 3.0 | 2.7 | 2.7 | 2.0 | 3.2 |
| Melt viscosity (mPa · s | | 12629 | 10532 | 167936 | 51009 | 110589 |
| at 120° C.) | | | | | | |

### Example 7: Preparation of a Silica-Coated Poly-s-Caprolactone (PCL) Particle (A)(Inventive)

120 g of the silica dispersion from example 1 and 160 g of Placcel H1P (Daicel Chemical Industries Ltd.) were heated to 80° in a commercially available Labotop planetary mixer (PC Laborsystem GmbH, Maispracherstrasse 6, 4312 Magden, Switzerland) equipped with a paddle agitator, a dissolver disc, and a scraper. Once the polyester had melted completely, the mixture was dispersed at 6000 rpm for 10 min. A highly viscous, white polymer emulsion is produced.

The resulting homogeneous emulsion was diluted with 230 g of hot (8000) demineralized water at a dissolver speed of 3000 rpm and cooled to room temperature. For isolation, the inventive particles (A) were filtered off and dried in a drying oven at 40° C. for 24 h. A fine white powder is obtained. Examination by electron microscopy (SEM) shows that the particle surface is completely coated with silica and that the particles are nonporous. The analytical data are summarized in Table 4.

### Example 8: Preparation of a Silica-Coated Poly(Butylene Succinate-Co-Adipate) (PBSA) Particle (A)(Inventive)

240 g of the silica dispersion from example 1 and 320 g of transesterified poly(butylene succinate-co-adipate) (PBSA) from example 2 were heated to 90° C. in a commercially available Labotop planetary mixer (PC Laborsystem GmbH, Maispracherstrasse 6, 4312 Magden, Switzerland) equipped with a paddle agitator, a dissolver disc, and a scraper. Once the polyester had melted completely, the mixture was dispersed at 6000 rpm for 10 min. A highly viscous, white polymer emulsion is produced.

The resulting homogeneous emulsion was diluted with 500 g of hot (90° C.) demineralized water at a dissolver speed of 3000 rpm and cooled to room temperature. For isolation, the inventive particles A were filtered off and dried in a drying oven at 40° C. for 24 h. A fine white powder is obtained. Examination by electron microscopy (SEM) shows that the particle surface is completely coated with silica and that the particles are nonporous. The analytical data are summarized in Table 4.

### Example 9: Preparation of a Silica-Coated Polyester Particle (A) of Polyester Having a Melting Temperature of 90 to 160° C. (Inventive)

A Versoclave laboratory pressure reactor (Büchi AG, Gschwaderstrasse 12, 8610 Uster/Switzerland) was charged with 113 g of the silica dispersion from example 1 and 191 g of a transesterified polyester from one of the inventive examples 3 to 6. The unit was closed, pressurized with nitrogen to 10 bar, and heated to an internal temperature of 150° C. The mixture was then mixed at 2500 rpm for 10 min. The stirring speed was reduced to 500 rpm and the mixture cooled to RT and depressurized. The resulting homogeneous particle dispersion was diluted with 200 g of demineralized water at 500 rpm. For isolation, the inventive particles A were filtered off and dried in a drying oven at 40° C. for 24 h. A fine white powder is obtained. Examination by electron microscopy (SEM) showed that the particle surfaces are completely coated with silica and that the particles are nonporous. The analytical data are summarized in Table 4.

### Comparative Example V1: Reworking of Example 3 from EP 3 489 281 A1 (Noninventive)

In accordance with example 3 from EP 3 489 281 A1, 40 g of BioPBS™ FZ71 (Mitsubishi Chemical Performance Polymers), 60 g of 3-methyl-3-methoxybutanol (99%, Acros Organics™), and a dispersion of 3 g of hydrophobic silica 2 in 100 g of demineralized water were mixed in a Versoclave laboratory pressure reactor (Buchi AG, Gschwaderstrasse 12, 8610 Uster/Switzerland). The mixture was stirred at 120° C. and 400 rpm for 90 min and then quickly cooled to room temperature while stirring. For isolation, the noninventive particles were filtered off and dried in a drying oven at 40° C. for 24 h. A lumpy white powder is obtained. Examination by electron microscopy (SEM) shows that the particle surface is only partially coated with silica and that the particles have a porous structure. The analytical data are summarized in Table 4.

### Comparative Example V2: Reworking of Example 5 from EP 3 489 281 A1 (Noninventive)

In analogous manner to example 5 from EP 3 489 281 A1, 60 g of BioPBS™ FZ71 (Mitsubishi Chemical Performance Polymers), 180 g of 3-methyl-3-methoxybutanol (99%, Acros Organics™), and a dispersion of 3 g of hydrophobic silica 2 in 360 g of demineralized water were mixed in a Versoclave laboratory pressure reactor (Buchi AG, Gschwaderstrasse 12, 8610 Uster/Switzerland). The mixture was stirred at 120° C. and 400 rpm for 90 min and then quickly cooled to room temperature while stirring. For isolation, the noninventive particles were filtered off and dried in a drying oven at 40° C. for 24 h. A lumpy white powder is obtained. Examination by electron microscopy (SEM) shows that the particle surface is only partially coated with silica and that the particles have a porous structure. The analytical data are summarized in Table 4.

### Comparative Example V3: Preparation of an Aqueous Silica Dispersion Containing 20% by Weight of Silica 2 (Noninventive)

The procedure was analogous to that of example 1, but using silica 2 instead of silica 1. Silica 2 was not completely dispersible in water and it was not possible to produce a suitable silica dispersion.

### Comparative Example V4: Preparation of an Aqueous Silica Dispersion Containing 1.1% by Weight of Silica 2 (Noninventive)

The procedure was analogous to that of example 1, but using 52 g of silica 2 instead of silica 1. A low-viscosity dispersion having a solids content of 1% and a pH of 4.5 is obtained.

### Comparative Example V5 (Noninventive)

The procedure was analogous to that of example 3 of the present invention, except that the noninventive silica dispersion from comparative example V4 was used instead of the inventive silica dispersion from example 1. It was not possible to produce a homogeneous, finely-divided particle dispersion.

### Comparative Example V6: In Analogous Manner to Example 6 from EP 3 489 281 A1 (Noninventive)

The procedure was analogous to that of example 6 from EP 3 489 281 A1, except that silica 1 was used. 120 g of BioPBS™ FZ71 (Mitsubishi Chemical Performance Polymers), 210 g of 3-methyl-3-methoxybutanol (99%, Acros Organics™), and a dispersion of 9 g of partially water-wettable silica 1 in 270 g of demineralized water were mixed in a Versoclave laboratory pressure reactor (Büchi AG, Gschwaderstrasse 12, 8610 Uster/Switzerland). The mixture was stirred at 120° C. and 400 rpm for 90 min and then quickly cooled to room temperature while stirring. For isolation, the noninventive particles were filtered off and dried in a drying oven at 40° C. for 24 h. A lumpy white powder is obtained. Examination by electron microscopy (SEM) shows that the particle surface is only partially coated with silica and that the particles have a porous structure. The analytical data are summarized in Table 4.

TABLE 4
Description of the core-shell particles produced

| | | Median | Silicon | | |
|---|---|---|---|---|---|
| | | particle | content | | |
| | Polyester | diameter × 50 | (% by | Sphericity | |
| Example | used | (μm) | weight) | SPHT | Comment |
| 8 | Placcel H1P | 9.5 | 5.6 | 0.88 | inventive |
| 9 | Example 2 | 8.7 | 4.7 | 0.86 | inventive |
| 10 | Example 3 | 7.7 | 4.5 | 0.89 | inventive |
| 11 | Example 4 | 9.4 | 5.1 | 0.90 | inventive |
| 12 | Example 5 | 8.3 | 4.5 | 0.88 | inventive |
| 13 | Example 6 | 9.2 | 4.9 | 0.86 | inventive |
| V1 | BioPBS ™ | 23 | 2.2 | 0.87 | noninventive |
| | FZ71 | | | | |
| V2 | BioPBS ™ | 15 | 1.8 | 0.89 | noninventive |
| | FZ71 | | | | |
| V5 | Example 3 | — | — | — | noninventive |
| V6 | BioPBS ™ | 26 | 2.4 | 0.78 | noninventive |
| | FZ71 | | | | |

### Example 14: Determination of Linseed Oil Adsorption

Linseed oil adsorption was determined according to the procedure described in EP 3 489 281 A1.

TABLE 5

| | Particles | Linseed oil adsorption | |
|---|---|---|---|
| Example | used | (ml/100 g) | Comment |
| 15 | Example 9 | 169 | inventive |
| 16 | Example | 178 | inventive |
| | 10 | | |
| V7 | Example | 116 | noninventive |
| | V6 | | |
| V8 | Example | 112 | noninventive |
| | V2 | | |

### Example 17: Determination of Biodegradability

The biodegradability of the core-shell particles from inventive examples 8, 9, 10, and 11 was determined by the CO2 evolution test according to OECD 301 B. The core-shell particles from inventive examples 8, 9, 10, and 11 met the criteria of “ready biodegradability”.

### Example 18: Evaluation of Dispersibility in Water

A sample vessel is charged with 20 ml of demineralized water, and 0.5 g of the particle to be evaluated is added. The vessel is closed and the mixture is vigorously shaken 10×. The test is passed (+) when the particle goes completely into the water phase and a homogeneous, single-phase dispersion is produced.

TABLE 6

| Example | Particles used | Evaluation | Description | Comment |
|---|---|---|---|---|
| 19 | Example 8 | + | homogeneous | inventive |
| | | | white dispersion | |
| 20 | Example 9 | + | homogeneous | inventive |
| | | | white dispersion | |
| 21 | Example 10 | + | homogeneous | inventive |
| | | | white dispersion | |
| 22 | Example 11 | + | homogeneous | inventive |
| | | | white dispersion | |
| V9 | Example V6 | − | inhomogeneous, | noninventive |
| | | | some floating | |
| | | | particles | |
| V10 | Example V2 | − | inhomogeneous, | noninventive |
| | | | some floating | |
| | | | particles | |

1-13. (canceled)

14. Core-shell particles (A), comprising:
a core (B) comprising a thermoplastic polyester (C) with a melting range of lower than 160° C.;
a shell (D) comprising partially water-wettable particles (E) of metal oxide, wherein the partially water-wettable particles (E) have a methanol value of less than 30; and
where the metal content of the core-shell particles (A) is at least 2.5% by weight.

15. The core-shell particles (A) of claim 14, wherein the melting temperature of the thermoplastic polyester (C) is in the range of 45 to 160° C.

16. The core-shell particles (A) of claim 14, wherein the thermoplastic polyester (C) is selected from polycaprolactone (PCL), poly(butylene succinate) (PBS), poly(butylene succinate-adipate) (PBSA), poly(butylene adipate-terephthalate) (PBAT), polyhydroxyalkanoate (PHA), polyhydroxybutyrate (PHB), polyhydroxyvalerate (PHV), polyhydroxybutyrate-hydroxyvalerate copolymers (PHBV) or mixtures thereof.

17. The core-shell particles (A) of claim 14, wherein the partially water-wettable particles (E) are particles of aluminum(III) oxide, titanium(IV) oxide or silicon(IV) oxide.

18. The core-shell particles (A) of claim 14, wherein the partially water-wettable particles (E) have a BET specific surface area of 30 to 500 m²/g.

19. The core-shell particles (A) of claim 14, wherein the partially water-wettable particles (E) have a Mohs hardness of greater than 1.

20. The core-shell particles (A) of claim 14, wherein the partially water-wettable particles (E) have a methanol value of less than 30.

21. The core-shell particles (A) of claim 14, wherein the silicon content is at least 2% by weight based on the core-shell particles (A).

22. A process for producing core-shell particles (A), comprising the steps of:
providing a core (B) comprising a thermoplastic polyester (C) with a melting range of lower than 160° C.;
providing a shell (D) comprising partially water-wettable particles (E) of metal oxide, wherein the partially water-wettable particles (E) have a methanol value of less than 30;
wherein the metal content of the core-shell particles (A) is at least 2.5% by weight;
wherein in a first step, the thermoplastic polyester (C) is heated to above its melting range, and accordingly becomes free-flowing, and emulsified with the partially water-wettable particles (E) in water, forming a particle-stabilized oil-in-water emulsion (G) having a discontinuous phase comprising molten polyester (C) and a continuous water-containing phase;
wherein in a second step, the particle-stabilized oil-in-water emulsion (G) is cooled to below the melting range of the polyester (C), wherein the molten, particle-stabilized polyester droplets (C) solidify and the partially water-wettable particles (E) become attached to the surface of the polyester particles (C), forming the core-shell particles (A).

23. The process of claim 22, wherein the melting temperature of the thermoplastic polyester (C) is in the range of 45 to 160° C.

24. The process of claim 22, wherein the thermoplastic polyester (C) is selected from polycaprolactone (PCL), poly(butylene succinate) (PBS), poly(butylene succinate-adipate) (PBSA), poly(butylene adipate-terephthalate) (PBAT), polyhydroxyalkanoate (PHA), polyhydroxybutyrate (PHB), polyhydroxyvalerate (PHV), polyhydroxybutyrate-hydroxyvalerate copolymers (PHBV) or mixtures thereof.

25. The process of claim 22, wherein the partially water-wettable particles (E) are particles of aluminum(III) oxide, titanium(IV) oxide or silicon(IV) oxide.

26. The process of claim 22, wherein the partially water-wettable particles (E) have a BET specific surface area of 30 to 500 m²/g.

27. The process of claim 22, wherein the partially water-wettable particles (E) have a Mohs hardness of greater than 1.

28. The process of claim 22, wherein the partially water-wettable particles (E) have a methanol value of less than 30.

29. The process of claim 22, wherein the silicon content is at least 2% by weight based on the core-shell particles (A).

30. The process of claim 22, wherein the particle-stabilized oil-in-water emulsion (G) has a continuous water phase that contains at least 80% by weight of water.

31. The process of claim 22, wherein the particle-stabilized oil-in-water emulsion (G) contains between 1% and 20% by weight of the partially water-wettable particles (E).

32. The process of claim 22, wherein the particle-stabilized oil-in-water emulsion (G) contains between 50% and 80% by weight of molten and accordingly free-flowing thermoplastic polyester (C).

33. The process of claim 22, wherein in the first step the polyester (C) heated to above the melting range is emulsified with the exclusion of an organic solvent.
